(19) United States
(12) Patent Application Publication
(10) Pub. No.: US 2024/0217177 A1
(43) Pub. Date: Jul. 4, 2024

(54) DEVICE AND METHOD FOR REMOVING AUXILIARY MATERIAL OF 3D-PRINTED WORKPIECES

(71) Applicant: XIONEER SYSTEMS GMBH, Wien (AT)

(72) Inventors: Andrei NEBOIAN, Wien (AT); Frank OSAN, Kelkheim (AT); Tobias PISTORA, Wien (AT); Stefan KITTENBERGER, Brunn am Gebirge (AT); Christian VEIT, Hoflein/Donau (AT); Jan BOCHNIG, Wien (AT)

(21) Appl. No.: 18/551,962

(22) PCT Filed: Mar. 22, 2022
(86) PCT No.: PCT/AT2022/060085

§ 371 Date: Sep. 22, 2023

(30) Foreign Application Priority Data
Mar. 23, 2021 (AT) A50197/2021
Mar. 23, 2021 (AT) A50198/2021
Dec. 11, 2021 (AT) A50905/2021
Dec. 11, 2021 (AT) A50906/2021

(51) Int. Cl. B29C 64/35; B08B 3/06; B08B 3/08; B29C 64/40; B33Y 40/20

(52) U.S. Cl. CPC B29C 64/35; B08B 3/06; B08B 3/08; B29C 64/40; B08B 2203/007; B33Y 40/20

(57) ABSTRACT

The invention relates to a method and a device for removing auxiliary material of 3D-printed workpieces (1), in particular for removing support material which is soluble in a dissolving liquid (3), wherein a drum (8) for receiving at least one workpiece (1) is provided, the drum (8) being at least partially filled with the dissolving liquid (3) for dissolving the auxiliary material, wherein the dissolving liquid (3) is suitable for and/or configured to dissolve the auxiliary material, and wherein a rotary drive (7) is provided, which sets the drum (8) in rotation for dissolving the auxiliary material.

The invention relates to a device and a method according to the generic terms of the independent patent claims.

When manufacturing 3D-printed workpieces, i.e. in particular when manufacturing workpieces by additive manufacturing, it is known to use auxiliary material that enables the construction of complexly shaped three-dimensional parts. During the production of workpieces by applying a molten plastic layer by layer, support structures often have to be printed as well to form protruding parts. According to the state of the art, these support structures are broken off the workpiece after completion. At the transition points to the support structure, the surface of the workpiece is often impaired. In particular, burrs may remain that must be removed in a separate work step.

To be able to avoid this, it is known to print support structures from an auxiliary material or support material, which can be dissolved by a solvent. The solvent is selected in such a way that it dissolves the auxiliary material, e.g. the support structure, but not the workpiece itself, leaving the workpiece behind after a certain time.

The use of soluble support material compared to support material that has to be broken off has several advantages.

As mentioned, the support material secures overhangs, bridges, cavities, etc. in the printing model during the printing process. For the support material to reliably fulfil this function, it must be able to adhere well to the model. Otherwise, it may be detached or slip during the printing process, which could then lead to a misprint. The greater the adhesion of the support material on the model and to the printing substrate, the more reliable is its support function. Conventional support materials usually have such a strong adhesion to the model materials that they can hardly be broken off mechanically without damaging the model. In particular, in order to avoid the problem of detachment or slippage of the support material during printing, soluble support materials are now offered.

Especially smaller and hard-to-reach cavities can hardly be mechanically and manually freed from the support material. But the liquid reaches hard-to-reach places more easily than a tool. This means that in the case of a soluble support material, these cavities can be freed from them much more easily by means of a solvent.

Another advantage of the soluble support material is that it can be removed without mechanical tools. This reduces or even completely eliminates the manual effort required to break off the support material. The dissolving of a soluble support material can be done automatically by wetting with the dissolving liquid. As a result, the soluble support material is often easier to use, quicker to remove, and ultimately more economical to use.

According to the prior art, the process is accelerated by setting the solvent in motion in a basin.

In particular, it is known to rotate a paddle wheel at the bottom of a basin in order to generate a flow in the basin. The operation of these devices substantially corresponds to that of a magnetic stirrer.

In addition, it is known to provide inlets and outlets for the solvent in the basin, and to pump the solvent through these openings with a powerful pump to create a flow.

In practice, however, these systems can cause problems.

In particular, parts of the workpiece or the support material may enter the pumps and thereby block or damage them. In addition, the flows generated by the impeller or the pump are relatively static, resulting in a very slow detachment of the auxiliary material in areas with a lower flow velocity.

The object of the invention is now to provide a device and a method for removing auxiliary material from 3D-printed workpieces, which operate reliably, quickly and gently. In particular, the device should be able to cause rapid dissolution of the auxiliary material. In addition, the device should gently remove the auxiliary material so that the workpieces are not destroyed during the process.

Even if a part of the auxiliary material or the workpiece becomes detached, this should not adversely affect or damage the device. The method should preferably be able to be carried out unattended, offer very high operational reliability and be as automated as possible.

The task of the invention is solved in particular by the features of the independent claims.

The invention relates to a device for removing auxiliary material from 3D-printed workpieces, in particular for removing support material soluble in a dissolving liquid, wherein a drum is provided for receiving at least one workpiece, wherein the drum is at least partially filled with the dissolving liquid, and wherein the dissolving liquid is suitable and/or configured for dissolving the auxiliary material.

According to the invention, a rotary drive is to be provided which sets the drum in rotation in order to dissolve the auxiliary material.

Optionally, it is provided that the at least one workpiece for removing the auxiliary material is or can be arranged in the drum in a substantially free-floating manner. In all embodiments, the device and the at least one workpiece arranged in the device can be regarded as an arrangement.

It may be advantageous if a flexible protective cover, such as in particular a bag made of a net-like fabric, is provided. Optionally, it is provided that the at least one workpiece is located in the protective cover when the auxiliary material is dissolved. The protective cover is preferably configured in such a way that the dissolving liquid can pass through the protective cover in order to release the auxiliary material from a workpiece. During the dissolving process, the protective cover and the drum are thus preferably at least partially filled with the dissolving liquid.

Optionally, it is provided that the workpiece in the protective cover is arranged floating freely in the drum.

Preferably, it is provided that the drum has an openable and closable door for inserting and removing the workpiece.

Optionally, it is provided that a closable liquid opening is provided, which acts as an inlet and/or outlet for the dissolving liquid.

Optionally, it is provided that the liquid opening is assigned a valve or a shut-off element for the controllable inflow or outflow of the dissolving liquid.

Optionally, it is provided that a heating device is provided for heating the dissolving liquid, wherein the heating device in particular heats the dissolving liquid arranged in the drum during the dissolving of the auxiliary material.

Optionally, it is provided that the rotatable drum is substantially liquid-tight and thereby acts as a container for the dissolving liquid.

Optionally, it is provided that the rotatable drum is designed to be liquid-permeable and has drum openings for the passage of the dissolving liquid. Optionally, it is provided that the drum projects into the dissolving liquid or is arranged in the dissolving liquid, which is arranged inside the container, whereby the drum is also at least partially filled with dissolving liquid.

Optionally, it is provided that at least one flow element protrudes from the rotatably driven drum into the dissolving liquid, wherein the flow element is configured to move the dissolving liquid and, in particular, to generate turbulence.

Optionally, it is provided that the dissolving liquid is arranged in the container substantially unmoved or stationary, and is mixed or set in motion only by the rotation of the drum and, if applicable, its flow element.

Optionally, the invention relates to a method for removing auxiliary material from 3D-printed workpieces, in particular for removing soluble support material, preferably in a device according to the invention.

It is advantageous if the auxiliary material is removed from the workpiece by arranging the at least one workpiece in a drum, that the drum for dissolving the auxiliary material is or will be at least partially filled with the dissolving liquid, the dissolving liquid being suitable and/or configured for dissolving, and that the drum for dissolving the auxiliary material is set in rotation by a rotary drive.

Optionally, it is provided that the at least one workpiece floats substantially freely in the drum for removing the auxiliary material.

Optionally, it is provided that a heating device heats the dissolving liquid, wherein the heating device in particular heats the dissolving liquid arranged in the drum during the dissolving of the auxiliary material. The dissolving liquid should flow around the heater as effectively as possible ensuring good heat transfer and avoiding evaporation on the surface of the heater.

Optionally, it is provided that the auxiliary material is dissolved during the movement of the workpiece in the dissolving liquid.

Optionally, it is provided that the auxiliary material is additionally detached mechanically by the movement of the workpiece by the dissolving liquid.

In most cases, the dissolving process can be accelerated by increased temperature. The temperature should be controlled or regulated to prevent deformation of the workpiece.

Heating can take place on the inside or via the container wall. Likewise, a partial stream from the container could be guided through a heating zone or a heat exchanger. The dissolving liquid may optionally be added preheated.

Optionally, it is provided that the container and/or the drum have an openable and closable door for inserting and removing the workpiece. The door can be provided or attached at the top or side, for example.

Optionally, a drying device is provided that dries the workpiece freed from auxiliary material.

Optionally, after dissolving the auxiliary material with solvent removed from the container, the movement device can be rotated at a higher speed in order to remove adhering liquid adhering to the workpiece by centrifugal force.

Alternatively or additionally, a drying device can be provided which, for example, guides heated air, in particular hot air, through the container and/or the drum in order to evaporate the dissolving liquid adhering to the workpiece.

In order to be able to reliably dry the workpiece, the temperature of the air should be controlled or regulated in order to avoid deformation of the workpiece when the air temperature is too high. Alternatively, a pre-dried air with a low dew point can be introduced.

Optionally, a filling level sensor is provided that allows the filling level of the container or the drum to be controlled. For example, this filling level sensor can be a weighing device provided in the area of the storage of the container or the drum. Alternatively, conventional filling level devices may be provided. The level measurement allows the selection of a certain filling of the container with the dissolving liquid.

In particular, smaller workpieces can be arranged in nets or flow-through bags.

An active movement of the dissolving liquid by pumps, propellers, nozzles, etc., should or can be omitted. Preferably, the movement of the workpiece by the liquid is intended to generate turbulence directly on the workpiece. This makes the turbulence much stronger and more effective. This speeds up the dissolving process.

Optionally, it is provided that the auxiliary material is dissolved during the movement of the workpiece in the dissolving liquid.

Optionally, it is provided that the auxiliary material is additionally mechanically detached, at least in parts, by the movement of the workpiece through the dissolving liquid.

Although the invention is not limited in principle to the use of a special dissolving liquid, it is preferably provided that the auxiliary material is an auxiliary material soluble in an alkali or an auxiliary material soluble in an alkali. The lye in which the auxiliary material has dissolved can easily be discharged into the wastewater after machining the workpiece. Optionally, a tank is provided in which the lye is stored in order to introduce it into the container. Depending on how much auxiliary material is already dissolved in the lye, the lye can be returned to the tank to be used again to remove auxiliary material.

Some auxiliary materials, for example, dissolve directly in water. The dissolved material can easily be separated from the workpiece with the dissolving liquid. A further washing step with fresh liquid can further improve the result.

The auxiliary material polystyrene (PS) can be dissolved, for example, with limonene (orange oil).

There are also auxiliary materials that can be dissolved with alcohol or other solvents.

Preference is given to harmless dissolving liquids such as water, weak alkalis or acids or weakly basic or acidic solutions, which may be optionally discharged into the drain.

By way of example, some exemplary combinations of auxiliary material with a suitable dissolving liquid and workpiece material can be mentioned:
Workpiece material: ABS, ASA, SAN, PA, pet, PC, PLA, but also others;
Auxiliary material: lye-soluble thermoplastics of carboxyl-containing polyacrylate-based copolymers or terpolymers (polycarboxylic acids) and/or mixtures thereof
Workpiece material: PLA, pet, but also others;
Auxiliary Material: Water-soluble thermoplastics such as polyvinyl alcohol (PVOH or PVA), butenediol-vinyl alcohol copolymer (BVOH) or hydroxypropylmethylcellulose (HPMC).
Workpiece material: Stratasys Objet®-Materials
Auxiliary Material: Associated SUP series support materials
Workpiece material: Photopolymers (e.g. model materials of the Keyence brand)
Auxiliary Material: Water-soluble materials (e.g. support materials of the Keyence brand).

Preferably, thermoplastics with a high softening temperature are combined with a support material that also has a higher heat resistance. This applies, for example, to specialised, lye-soluble thermoplastics based on polyacrylates.

It is also possible to use organic (flammable) solvents to dissolve the support material. For this purpose, careful protection against escaping vapours should be provided. It must also be ensured that no electrostatic charging, no short circuit, or strong heat formation occurs.

Optionally, the interior of the device can be filled with inert gas in order to prevent, for example, explosions. An example here is the use of polystyrene as a support material in conjunction with e.g. ABS. Limonene (orange oil) is often used as a solvent.

For high-performance thermoplastics such as polyether ketones (peek), polyether sulfone (PES), polysulfone (PSU) or polyphenyl sulfone (PPSU) can be used as a support material. Possible solvents here are dichloromethane or tetrahydrofuran. Because of the health hazard posed by organic solvents, the workpieces should be carefully freed of absorbed solvent under adequate conditions.

Optionally, the mixtures of support material and organic solvents must be sent to a hazardous waste disposal facility. Because of the high effort and risk, such variants are usually not preferred.

Turbulence in the solvent in the device can lead to increased foam formation in the device. In order to reduce foam formation, defoamers, foam inhibitors or foam smelting agents can be admixed before or during the dissolution process.

In the following, exemplary embodiments of the invention will be described.

Optionally, it is provided that the drum is rotated in one direction in a first phase of operation and in the opposite direction in a second phase. In particular, it may be provided that the rotary drive reverses the direction of rotation after a certain duration or a certain number of revolutions. Reversing the direction of movement can be done several times to improve the efficiency of the process and the device.

Optionally, it is provided that the axis of rotation of the rotary drive extends substantially horizontally. The axis of rotation of the drum can also preferably run horizontally. In particular, the axis of rotation of the drum and the axis of rotation of the rotary drive may be arranged coaxially. Alternatively, the axis of rotation of the movement device, in particular the axis of rotation of the rotary drive, can also run horizontally or in any other direction.

The door for inserting or removing the workpieces is preferably provided in the region of the end face of the drum. Alternatively, the door may be provided in the area of the jacket of the drum.

The opening of the drum and/or the container can also take place from above, in particular if the axis of rotation is tilted or has been selected vertically.

The drum may be designed to be openable or it may have drum openings of such a size that the workpieces can be introduced into the drum through these openings.

Preferably, the dissolving liquid is initially arranged substantially motionless in the container. By actuating the movement device, in particular by rotating the drum, the dissolving liquid can nevertheless be set in motion.

If the dissolving liquid is set in motion by the movement of the drum itself, the direction of movement of the drum can be reversed to restore sufficient relative movement to the workpiece.

Through this procedure, the formation of turbulence on the workpiece can be improved in order to improve the dissolving process.

Alternatively or additionally, at least one flow element may be provided, which influences the flow of the dissolving liquid in such a way that sufficient relative movement of the workpiece with respect to the dissolving liquid occurs. For example, a flow element provided on the drum can set the dissolving liquid in motion. The interaction of gravity, centrifugal force and, optionally, a flow element, which can deflect an accumulating flow and put it into turbulence, supports the dissolving process.

Optionally, it may be provided that the efficiency of the device and the process is improved by entraining the dissolving liquid through the drum and/or the flow element to drip off in another area.

Optionally, it may be provided that flow elements act as scoop structures in the drum, which entrain the liquid during rotation and then sprinkle it onto the workpieces from above.

Optionally, small free-floating objects with rough surfaces such as brushes or sponges can be added to the container. These rub against the auxiliary material during the dissolving process and thus serve to mechanically support the dissolving process. Furthermore, these objects remove possible deposits on the drum or the workpiece. Fibrous or sponge-like structures, which may be mounted in the container, can bind or filter small particles from the washing solution before these particles contaminate the surfaces of workpieces or machine parts.

The intensity of local turbulence can be easily adjusted via the movement characteristics of the drum. This allows the device to set a suitable turbulence to achieve a high dissolving force without damaging the workpiece.

Through suitably mounted viewing windows, the dissolving process can be continuously observed from the outside in order to obtain information about the dissolving progress. Cameras may also be used.

In all embodiments, it may be provided that the dissolving liquid is basically at rest in the container, but is swirled or moved by the drum.

In all embodiments, it may be provided that the device has at least one horizontally or at least one vertically arranged shaft. The drum may be arranged on the at least one shaft. The at least one shaft may extend from both sides of the drum toward the housing of the device. Optionally, the drum may be connected to the housing on both sides via the at least one shaft.

Optionally, it is provided that a movement device, in particular the rotary drive, transmits a movement, in particular a rotary movement, to the shaft and as a result, in particular, the drum is set in motion, in particular in rotation.

In the context of the present invention, a vertical shaft may be understood to mean a shaft or a part of a shaft which is arranged, in particular substantially, perpendicular to the ground on which the device stands.

In the context of the present invention, a horizontal shaft may be understood to mean a shaft or a part of a shaft which is arranged, in particular substantially, horizontally with respect to the ground on which the device stands.

Optionally, the device may comprise a braking device, wherein the braking device is configured to decelerate the movement, in particular the rotation, of the drum.

In particular, it may be provided that the device, in particular the container and/or the drum, has two openable and closable doors for inserting or removing the workpieces. Optionally, the two doors may be arranged opposite one another on the device, in particular on the container and/or on the drum. In particular, workpieces, in particular the container and/or the drum, can be introduced into the device through both doors. Optionally, the door, in particular the two doors, may be provided in the region of the lateral surface or longitudinal side of the container and/or the drum. It may therefore optionally be possible to load and unload the device, in particular the container and/or the drum, from both sides.

Optionally, it is provided that the door has a locking device so that the door is closed and/or locked when the container and/or the drum is moved.

The door can have a width in the range between 10 cm and 100 cm inclusive, in particular in the range between 70 cm and 80 cm inclusive. The width and height of the door can be, in particular, the size, preferably the diameter, of the drum. The width and height of the door may be greater than the diameter of the drum. The width and height of the door may optionally be at least half the size, in particular of the diameter, of the drum. The width and height of the door may optionally also be greater than half the size, in particular than the diameter, of the drum.

The door may have a height in the range between 10 cm and 100 cm inclusive, in particular in the range between 30 cm and 40 cm inclusive.

The door can be designed as a sliding door, a stop door and/or a folding door.

The drums can be designed as a drum with a Y-chamber, in particular a drum with 3 chambers, or as a Pullmann drum, in particular a drum with 2 chambers.

In particular, the device, the housing of the device, the container and/or the drum may be made of or comprise stainless steel.

Optionally, a control device with an operator interface is provided, which enables and/or allows the user to operate the device. In particular, the control device can control and/or regulate the movement device, the supply of the dissolving liquid, in particular the supply of the, optionally solvent-free, liquid, preferably the water and/or the solvent, preferably the dissolving powder, and/or the at least one valve.

Optionally, it is provided that a dosing device is to be provided for metering the solvent, in particular the dissolving powder. This dosing device can be controlled and/or regulated via the control device. This dosing device can be set up for dosing in the solvent. The dosing device can be designed, for example, as a peristaltic pump.

In particular, it can be provided that the concentration of the dissolving liquid, in particular the ratio of solvent, preferably of dissolving powder, to the, optionally solvent-free, liquid, in particular to water, in the device, in particular in the container and/or the drum, is controlled and/or regulated via the filling level sensor of the device.

In particular, the control device can be configured to adjust the filling level of the dissolving liquid and/or the concentration of the dissolving liquid via the filling level sensor.

Optionally, it is provided that a predetermined fill level in the device, in particular in the container and/or the drum, to be adjustable via the control device and/or the filling level sensor. As a result, it may be possible for the workpieces arranged in the device, in particular during the movement of the drum, to be moved by the dissolving liquid and/or to be immersed, preferably substantially completely, in the dissolving liquid. In particular, the workpieces can thereby be immersed, substantially completely, in the dissolving liquid, in particular during the movement of the drum.

In particular, the device and/or the movement device can be configured to move and/or rotate the drum for a period of time in the range from 5 minutes to 3000 minutes inclusive, in particular in the range from 15 minutes to 600 minutes inclusive, optionally of more than 90 minutes, preferably without interruption. Optionally, it is provided that the device and/or the movement device are configured in such a way that movement and/or rotation of the drum is possible for a period of time in the range from 5 minutes to 3000 minutes inclusive, in particular in the range from 15 minutes to 600 minutes inclusive, optionally for more than 90 minutes, preferably without interruption. In particular, it can be provided that the device and/or the movement device are configured to rotate the drum at a substantially constant rotational speed and/or at a, in particular constant, rotational speed, in particular in the range from 0.1 meters per second to 10 meters per second, preferably 0.5 meters per second to 5 meters per second, for the above-mentioned periods of time.

In particular, the device and/or the movement device comprises a cooling device, wherein the cooling device cools the movement device. By cooling the movement device, it may be possible for the movement device to rotate and/or move the drum without interruption.

In the context of the present invention, uninterrupted can be understood to mean that the drum is rotated and/or moved at a substantially constant speed and/or without standstill.

In order to speed up the dissolve process, the direction of rotation of the drum can be reversed at predetermined time intervals. The frequency of this reversal of the direction of rotation of the drum can be controlled and/or regulated by the control device.

In particular, the invention relates to a method for removing auxiliary material from 3D-printed workpieces, in particular for removing soluble support material, preferably in a device according to the invention, comprising, in particular, further steps.

Optionally, introducing an optionally solvent-free liquid, in particular water, into the device, in particular into the container. Optionally, measuring and/or controlling the amount of liquid, in particular introduced, possibly solvent-free, by means of a sensor, in particular the filling level sensor.

Optionally, introducing a solvent, in particular a dissolving powder, into the device, in particular into the container.

Optionally, measuring and/or controlling the amount of solvent, in particular introduced, by means of a sensor, in particular the filling level sensor, and/or the dosing device.

Optionally, in particular with the method, the concentration of the dissolving liquid, in particular the ratio of the solvent, preferably the dissolving powder, to the, optionally solvent-free, liquid, in particular water, can be adjustable in the device, in particular in the container and/or the drum.

The concentration of the dissolving liquid can be in the range of 0.4 grams of solution powder per litre, optionally solvent-free liquid, in particular water, up to and including 100 grams of solution powder per litre, optionally solvent-free liquid, in particular water. Optionally, liquid solvents or detergents, preferably alkaline solvents in a mixture or as a pure substance, in particular, for example, aminoethanol, can also be used as substitutes for solution powders. The concentration of the dissolving liquid can be in the range of 10 grams of solution powder per litre, optionally solvent-free liquid, in particular water, up to and including 34 grams of solution powder per litre, optionally solvent-free liquid, in particular water. The concentration of the dissolving liquid can be in the range of 5 grams of solution powder per litre, optionally solvent-free liquid, in particular water, up to and including 50 grams of solution powder per litre, optionally solvent-free liquid, in particular water.

In the context of the present invention, the concentration of the solvent liquid can be understood as the ratio between the solvent and the, optionally solvent-free, liquid, in particular water.

In particular, the invention relates to a method for removing auxiliary material from 3D-printed workpieces, in particular for removing soluble support material, preferably in a device according to the invention, comprising, in particular, further steps.

Optionally, determining at least one dimension of the printed workpiece by means of a measuring device.

Optionally, introducing the printed workpiece into the device, in particular into the drum. Optionally, introducing a dissolving liquid, in particular a liquid and/or a solvent, which may be solvent-free, into the device, in particular into the container.

Optionally, measuring and/or controlling the amount of dissolving liquid, in particular introduced, by means of a sensor, in particular the filling level sensor, on the basis of the specific dimension of the workpiece. Optionally, the printed workpiece is covered by the dissolving liquid, in particular at least temporarily, preferably substantially completely.

Optionally, the filling level in the device, in particular in the container and/or the drum, can be adjusted by means of the control device and/or the dosing device in such a way that the printed workpieces, in particular during the movement of the drum, are immersed, preferably substantially completely, in the dissolving liquid.

The drum of the device can have a volume of 1 litre up to and including 10,000 litres, preferably a volume of 10 litres up to and including 2000 litres, in particular 20 litres up to 1800 litres. In particular, the drum of the device may have a volume of 30 litres, 40 litres, 50 litres, 60 litres, 70 litres, 80 litres, 90 litres, 100 litres, 110 litres, 120 litres, 600 litres, 700 litres, 800 litres, 900 litres, 1000 litres, 1100 litres, 1200 litres, 1300 litres, 1400 litres, 1500 litres, 1600 litres, 1700 litres, 1800 litres, and/or 1900 litres.

In order to be able to minimize an imbalance of the drum during rotation, it may be advantageous to load the drum uniformly.

The maximum load can substantially depend on the geometry of the workpieces, the structure of the workpieces and the proportion of supports, as well as on the geometry of the drum. The amount of solvent required to dissolve the support material can optionally be determined from the machine program of the additive manufacturing process of the workpiece, in particular, for example, GCODE. In particular, the amount of solvent required can be transmitted to the control device, which optionally adjusts it. Optionally, it is derived from the fact that different geometries of the support structures and the models as well as different support materials result in a wide selection of possible solvent concentrations and filling quantities.

The diameter of the drum can be 10 cm up to and including 200 cm, in particular 40 cm, 50 cm, 60 cm, 70 cm, 80 cm, 90 cm, 100 cm, 110 cm, 120 cm, 130 cm, 140 cm and/or 150 cm.

The ratio between the drum diameter and the drum length may optionally be in the range of 1:5 to 10:1 inclusive (diameter: Length). Preferably, the ratio between the drum diameter and the drum length can be in the range of 1:3 to 5:1, inclusive (diameter: Length). Particularly preferably, the ratio between the drum diameter and the drum length can be in the range between 1:2 and 3:1 inclusive (diameter: Length).

The rotational speed of the drum during the dissolve process can be in the range of 0.1 meters per second up to and including 10 meters per second, in particular 0.5 meters per second up to and including 5 meters per second, preferably 1 meter per second up to and including 3 meters per second.

In the context of the present invention, the rotational speed of the drum can be understood as the tangential speed at the edge, in particular at the lateral surface, of the drum. Optionally, this rotational speed corresponds to the speed at which the workpiece is moved through the liquid.

The heating device can be designed as a steam heating device and/or as an electric heating device.

Preferably, the heating device is controlled and/or regulated, in particular by the control device, in order to set a specific temperature or a temperature profile during the dissolve process.

In particular, the invention relates to the use of a device for removing auxiliary material of 3D-printed workpieces, in particular for removing support material which is soluble in a dissolving liquid, wherein a drum is provided for receiving at least one workpiece, wherein the drum is at least partially filled with the dissolving liquid for dissolving the auxiliary material, wherein the dissolving liquid is suitable and/or configured for dissolving the auxiliary material, and wherein a rotary drive is provided which sets the drum in rotation for dissolving the auxiliary material.

In particular, the invention relates to the use of the device according to the invention for removing auxiliary material from 3D-printed workpieces.

Optionally, further devices, such as, in particular, registers, shafts, drawers and/or shelves, are arranged in the drum, which are configured to load, distribute and/or fix the workpieces in the drum, in particular on different levels.

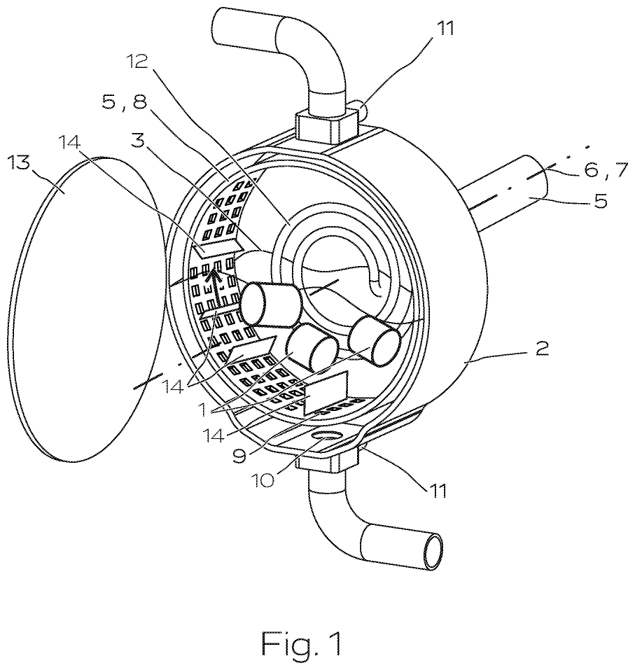

FIG. 1 shows a schematic oblique view of components of a first embodiment.

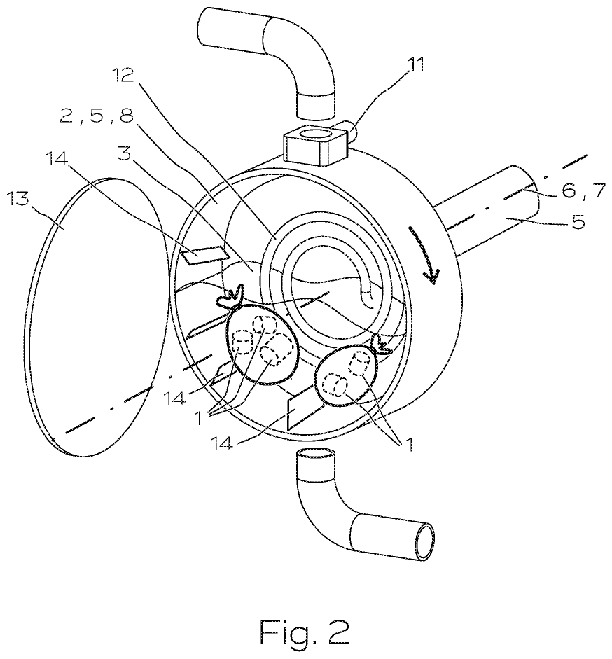

FIG. 2 shows a schematic oblique view of components of a second embodiment.

Unless otherwise indicated, the reference numbers correspond to the following components: workpiece 1, container 2, dissolving liquid 3, movement device 5, rotation axis 6, rotary drive 7, drum 8, drum opening 9, liquid opening 10, valve 11, heating device 12, door 13, flow element 14.

FIG. 1 shows a schematic oblique view of components of a first embodiment. To remove auxiliary material of 3D-printed workpieces 1, they are introduced into a drum 8. An openable and closable door 13 is provided for this purpose. In the present embodiment, the drum 8 is designed to be liquid-permeable and has several drum openings 9. The drum 8 is arranged in a container 2. In particular, the container 2 may be closed by the door 13.

Preferably, the auxiliary material is a support material that is also printed by 3D printing during the production of the workpiece 1. This support material is preferably made of a different material than that part of the workpiece 1 from which the auxiliary material is to be removed. The dissolving liquid 3 is preferably selected such that the auxiliary material is soluble in the dissolving liquid 3 and can be dissolved therein. In addition, the auxiliary material can also be detached from the actual workpiece 1 by mechanical detachment.

Subsequently, the door 13 is closed and the process can be started. In a first step, the dissolving liquid 3 is introduced into the container 2 or into the drum 8 until a certain filling level is reached.

Optionally, the drum 8 can be filled completely or only partially with the dissolving liquid 3. The dissolving liquid 3 is suitable and/or configured for dissolving the auxiliary material of the workpiece 1. For the introduction of the dissolving liquid 3, the device has a liquid opening 10 which can be opened and closed by a valve 11. A control device takes over the control of the valve 11 and, optionally, also the control or regulation of the filling level.

A movement device 5 is provided to improve the efficiency of dissolving the auxiliary material. This movement device 5 comprises a rotary drive 7 for moving, in particular rotating, the drum 8.

During the dissolving process, the workpieces 1 are preferably freely floating in the drum 8. Only one workpiece 1 or several workpieces 1 can be arranged in the drum 8.

The drum 8 is rotated by the rotary drive 7 around an axis of rotation 6. The axis of rotation 6 is preferably coaxial with the axis of rotation of the shape of the drum 8.

To further improve the efficiency of the device, at least one flow element 14 may be provided. In the present embodiment, this flow element 14 is attached to the drum 8, in particular to the inside of the drum 8. When the drum 8 moves, the flow element 14 is also moved. The flow element 14 creates turbulence in the dissolving liquid 3.

Optionally, the flow elements 14 may be designed in such a way that, when the drum 8 rotates, the flow elements pick up dissolving liquid 3, transport it upwards and dissolve it again at a certain point. The flow elements 14 can thus act as a kind of scooping mechanism that allows the dissolving liquid 3 to drip off from above. The flow elements 14 may, for example, be designed as obliquely arranged lamellas.

Optionally, the flow elements 14 may be configured in such a way that, when the drum 8 rotates, they entrain the workpieces 1, transport them upwards and drop them back into the liquids in order to improve the dissolving process.

To further improve the efficiency of the device, it may be provided that the rotary drive 7 reverses the direction of rotation of the drum 8 from time to time.

During this process, the workpieces 1 are preferably freely floating in the dissolving liquid 3 and are not attached to the drum 8 or to the container 2.

To further improve the efficiency of the device, a heating device 12 may be provided to heat the dissolving liquid 3. Preferably, the heating device 12 is controlled and/or regulated to set a specific temperature or temperature profile during the dissolving process.

The temperature should be high enough to improve the dissolving of the auxiliary material in the dissolving liquid 3, but low enough to avoid damaging or softening the workpiece 1 too much.

In the present embodiment, the drum 8 is configured to be liquid-permeable. In particular, the drum 8 has a plurality of drum openings 9. Optionally, the drum 8 can be formed from a continuous material, which is provided with a plurality of drum openings 9 during production. Likewise, the drum 8 can be a grid-shaped structure such as a cage-shaped drum 8.

The drum 8 is arranged in the container 2. If the container 2 is now at least partially filled with the dissolving liquid 3, the dissolving liquid 3 penetrates into the drum 8 through the drum openings 9. As a result, the drum 8 is also at least partially filled with a dissolving liquid 3. FIG. 2 shows a schematic oblique view of components of a second embodiment. The components identified by reference numerals correspond to the components of FIG. 1.

The workpieces 1 are arranged inside a rotatably driven drum 8. In the present case, the workpieces 1 are arranged in a flexible protective cover. Such a flexible protective cover can of course also be used in the embodiment of FIG. 1, just as in the embodiment of FIG. 2 the workpieces 1 can be arranged directly, i.e. without a protective cover, in the container 2.

In the embodiment of FIG. 2, the drum 8 is designed to be liquid-tight and thus acts as a container 2. Again, during the dissolve process, the drum 8 is set in motion by a movement device 5. In particular, a rotary drive 7 is provided which rotates the drum 8 about the axis of rotation 6. The process for removing the auxiliary material preferably corresponds to that in FIG. 1.

One difference between the two embodiments is that in FIG. 2, the liquid opening 10 for introducing and discharging the dissolving liquid 3 must be aligned with respect to the supply lines in such a way as to allow the introduction or discharge of the dissolving liquid 3. In particular, when the drum 8 rotates, the liquid opening 10 can be closed by a valve 11 to prevent the dissolving liquid 3 from escaping. In the present embodiment, only one liquid opening 10 is provided, which can be closed via a valve 11. To introduce the dissolving liquid 3, it is positioned at the supply line for the dissolving liquid 3. To discharge the dissolving liquid 3, the liquid opening 10 is positioned at the discharge. By controlling the valve 11, a liquid transport may be achieved.

The drum 8 can also have several liquid openings 10 and valves 11 in order to speed up, for example, the loading and unloading, as well as the flushing through with liquid.

The device comprises a heating device 12. The heating device 12 is configured to heat the dissolving liquid 3. In particular, the dissolving liquid 3 is heated to a temperature at which the dissolving effect of the auxiliary material is improved.

The heating device 12 preferably acts on the dissolving liquid 3 located in the container 2. In the present embodiment, the heating device 12 is disposed within the container 2. In principle, however, the heating device 12 can also be provided in a bypass line through which the dissolving liquid 3 is pumped in order to get back into the container 2.

Alternatively or additionally, heating mats can be attached to the outside of the container 2, which heat the container 2 together with the dissolving liquid 3. The heating device 12 can also be mounted in the lower half of the container 2 in order to achieve the most efficient possible flushing of the heating elements by the dissolving liquid.

In the embodiments of FIGS. 1 and 2, a housing (not shown) is preferably provided, in which the components shown are arranged. The door 13 is preferably accessible from the outside.

A control device with an operator interface is preferably provided, which allows the user to operate the device and which enables the control of the rotary drive 7 and the at least one valve 11.

Optionally, a tank (not shown) is provided for receiving the dissolving liquid 3, into which the dissolving liquid 3 can be discharged when the workpiece 1 is to be removed. Optionally, however, the dissolving liquid 3 can also be directed directly into the drain.

A method for removing auxiliary material from 3D-printed workpieces 1, in particular for removing soluble support material, can optionally proceed as follows: The workpiece 1 is usually printed from an ABS plastic on a 3D printer, for example on an industrial 3D printer using the FFF-method.

So that undercuts and/or overhangs of the workpiece 1 can be printed, an auxiliary material and in particular a support material is used.

For example, a 3D printer with two push heads is used—so the printer can print a support material in addition to ABS. As a support material, for example, a lye-soluble thermoplastic based on polyacrylate (co- or terpolymeric polyacids) can be used.

For example, the finished printed workpiece 1 has dimensions of 100×100×100 mm and consists of 150 g ABS and 80 g soluble support material.

In the next step, the printed workpiece 1 is freed from the support material. The device according to the invention is used in particular for this purpose.

The container 2 or the drum 8 of an exemplary embodiment has a diameter of 200-800 mm, in particular of approximately 500 mm or 480 mm. The depth is, for example, 100-500 mm, in particular approx. 350 mm or 300 mm. The components are made of a material that is resistant to the dissolving liquid, especially at higher temperatures. The container 2 can be made, for example, of alkaline and temperature-resistant polypropylene.

The drum 8 may be made of stainless steel, for example.

In a next step, the workpiece is positioned freely within the container 2 or within the drum 8.

In the next step or in advance, the dissolving liquid 3 can be produced. For this purpose, for example, 80 g of dissolving powder based on sodium carbonate are mixed with 20 litres of water at room temperature. This mixture has a pH of about 10.

Subsequently, the dissolving liquid 3 is filled into the container 2 through the liquid opening 10. The dissolving liquid 3 is configured to dissolve the support material in the device under certain conditions (temperature and agitation). The seals in the door 13 prevent the dissolving liquid 3 from escaping to the outside.

Subsequently or before this, the heating device 12 is activated, for example with a maximum heating power of 2000 W, and the drum 8 is set in motion. The movement is achieved, for example, by means of a 300 watt universal drive and a mechanical belt ratio of 1:17.

In all embodiments, the movement and/or the heating power are preferably controlled and/or regulated by a suitable microcontroller-programmed automated controller including a user interface.

After about two hours, depending on the ambient and water temperature, the dissolving liquid reaches the operating temperature. The operating temperature should be set so that the workpiece material (e.g. ABS) does not thermally deform, but is at the same time high enough to accelerate the dissolving performance. For example, an operating temperature of 75° C. can be selected for the ABS workpiece material used.

The speed of rotation of the drum 8 can be adjusted with the control. For most workpieces 1 with wall thicknesses greater than 2 mm, a good guideline value of 50 rpm has proven to be advantageous.

During the dissolving process, the device reverses the direction of movement of the drum 8 more often, optionally, for example, every 2 minutes. This procedure allows intensive rinsing of the workpiece 1 with the dissolving liquid 3 at any point over the entire dissolving cycle.

After about six hours, the dissolving process is complete and the workpiece is freed from auxiliary material.

The device now opens a valve 11 in order to drain the spent dissolving liquid 3. The dissolving liquid 3 passes via the drain pipe into a collecting container for subsequent disposal. For example, the spent solvent after this process has a pH of 9.6.

In order to clean the surface of the workpiece 1 from the residues of the dissolving liquid 3, the container can be filled with fresh water via a liquid opening 10. The device sets the drum 8 in motion again, for example, in rotation at 50 rpm. This cleaning process takes about 10 minutes, for example, and the direction of rotation can also be changed here, e.g. every 2 minutes.

Subsequently, the water is disposed of via a Liquid opening 10. Re-rotation can help to free the workpiece from adhering water.

An increase in speed favours this process.

The undamaged workpiece, which has been completely removed from the support material, can now be removed from the device and, optionally, dried under room conditions. For complete removal of water that has penetrated capillary cavities, vacuum drying at elevated temperature may be advantageous.

1. A device for removing auxiliary material from 3D-printed workpieces (1), in particular for removing support material soluble in a dissolving liquid (3),
wherein a drum (8) is provided for receiving at least one workpiece (1),
wherein the drum (8) is at least partially filled with the dissolving liquid (3) for dissolving the auxiliary material,
and wherein the dissolving liquid (3) is suitable and/or configured for dissolving the auxiliary material,
characterized in that a rotary drive (7) is provided which causes the drum (8) to rotate in order to dissolve the auxiliary material.

2. The device according to claim 1, characterized in that the at least one workpiece (1) for removing the auxiliary material is arranged substantially freely floating in the drum (8).

3. The device according to claim 1, characterized in that a flexible protective cover, such as in particular a bag made of a net-like fabric, is provided,
that the at least one workpiece (1) is located in the protective cover when the auxiliary material is dissolved,
and that the workpiece (1) is arranged in the protective cover in a freely floating manner in the drum (8).

4. The device according to claim 1, characterized in that the drum (8) has an openable and closable door (13) for inserting and removing the workpiece (1).

5. The device according to claim 1, characterized in that
a closable liquid opening (10) is provided, which acts as an inlet and/or outlet for the dissolving liquid (3),
and in that the liquid opening (10) is assigned a valve (11) or a shut-off element for the controllable supply or discharge of the dissolving liquid (3).

6. The device according to claim 1, characterized in that a heating device (12) is provided for heating the dissolving liquid (3), wherein the heating device (12) in particular heats the dissolving liquid (3) arranged in the drum (8) during the dissolving of the auxiliary material.

7. The device according to claim 1, characterized in that
the rotatable drum (8) is substantially liquid-tight and thereby acts as a container (2) for the dissolving liquid (3),
or in that the rotatable drum (8) is designed to be liquid-permeable and has drum openings (9) for the dissolving liquid (3) to pass through, the drum (8) protruding into the dissolving liquid (3) or being arranged in the dissolving liquid (3), which is arranged within a stationary container (2), with which the drum (8) is also at least partially filled with dissolving liquid (3).

8. The device according to claim 1, characterized in that
at least one flow element (14) protrudes from the rotatably driven drum (8) into the dissolving liquid (3),
wherein the flow element (14) is configured to move the dissolving liquid (3) and in particular to generate turbulence.

9. The device according to claim 1, characterized in that the dissolving liquid (3) is arranged in the container (2) substantially unmoved or stationary and is mixed or set in motion only by the rotation of the drum (8) and optionally its flow element (14).

10. A method for removing auxiliary material from 3D-printed workpieces (1), in particular for removing soluble support material, preferably in a device according to claim 1, wherein the auxiliary material is thereby removed from the workpiece (1),
that the at least one workpiece (1) is arranged in a drum (8),
that the drum (8) is or will be at least partially filled with the dissolving liquid (3) for dissolving the auxiliary material, wherein the dissolving liquid (3) is suitable and/or configured for dissolving the auxiliary material,
and that the drum (8) is set in rotation by a rotary drive (7) in order to dissolve the auxiliary material.

11. The method according to claim 10, characterized in that the at least one workpiece (1) for removing the auxiliary material floats substantially freely in the drum (8).

12. The method according to claim 10, characterized in that a flexible protective cover such as, in particular, a bag made of a net-like fabric is provided,
that the at least one workpiece (1) is located in the protective cover when the auxiliary material is dissolved,
and that the workpiece (1) is arranged in the protective cover in a freely floating manner in the drum (8).

13. The method according to claim 10, characterized in that a heating device (12) heats the dissolving liquid (3), the heating device (12) heating, in particular, the dissolving liquid (3) arranged in the drum (8) when the auxiliary material is dissolved.

14. The method according to claim 10, characterized
that at least one flow element (14) protrudes from the rotatably driven drum (8) into the dissolving liquid (3),
wherein the flow element (14) is configured to move the dissolving liquid (3) and in particular to generate turbulence.

15. The method according to claim 10, characterized in that the dissolving liquid (3) is arranged in the container (2) in a substantially unmoving or stationary manner, and is mixed or set in motion only by the rotation of the drum (8).

16. The method according to claim 10, characterized
that the auxiliary material is dissolved in the dissolving liquid (3) during the movement of the workpiece (1),
and, optionally, that the auxiliary material is additionally mechanically detached by the movement of the workpiece (1) through the dissolving liquid (3).

17. The method according to claim 10, comprising, in particular further, the following steps:
introducing a liquid, optionally solvent-free, in particular water, into the device, in particular into the container (2) of the device,
measuring and/or controlling the amount of liquid, optionally solvent-free, by means of a sensor, in particular a filling level sensor,
optionally, introducing a solvent, in particular a dissolving powder, into the device, in particular into the container (2) of the device,
optionally, measuring and/or controlling the amount of solvent by means of a sensor, in particular the filling level sensor, and/or a dosing device.

18. The method according to claim 10, comprising, in particular further, the following steps:
determining at least one dimension of the printed workpiece (1) by means of a measuring device,
introducing the printed workpiece (1) into the device, in particular into the drum of the device,
introducing a dissolving liquid (3), in particular a liquid, optionally solvent-free, and/or a solvent into the device, in particular into the container (2) of the device,
measuring and/or controlling the amount of dissolving liquid (3) by means of a sensor, in particular the filling level sensor, on the basis of the determined dimension of the workpiece, so that the printed workpiece (1) is, at least temporarily, covered by the dissolving liquid (3).

19. A use of a device for removing auxiliary material from 3D-printed workpieces (1), in particular for removing support material soluble in a dissolving liquid (3),
wherein a drum (8) is provided for receiving at least one workpiece (1),
wherein the drum (8) is at least partially filled with the dissolving liquid (3) for dissolving the auxiliary material,
wherein the dissolving liquid (3) is suitable and/or adapted for dissolving the auxiliary material,
and wherein a rotary drive (7) is provided which causes the drum (8) to rotate in order to dissolve the auxiliary material.

20. (canceled)
